(19) United States
(12) Patent Application Publication
(10) Pub. No.: US 2010/0014394 A1
(43) Pub. Date: Jan. 21, 2010

(54) WRITE-ONCE-READ-MANY OPTICAL RECORDING MEDIUM AND RECORDING METHOD THEREFOR

(75) Inventors: Masayuki Fujiwara, Kanagawa (JP); Noboru Sasa, Kanagawa (JP); Yoshitaka Hayashi, Kanagawa (JP); Toshishige Fujii, Kanagawa (JP); Katsuyuki Yamada, Kanagawa (JP); Masaki Kato, Tokyo (JP); Shinya Narumi, Kanagawa (JP); Hideaki Oba, Kanagawa (JP); Hiroyoshi Sekiguchi, Kanagawa (JP); Toshihide Sasaki, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/438,823

(22) PCT Filed: Aug. 30, 2007
(86) PCT No.: PCT/JP2007/067364

§ 371 Date: Feb. 25, 2009

(30) Foreign Application Priority Data
Sep. 1, 2006 (JP) 2006-237618
Jul. 9, 2007 (JP) 2007-179958

(51) Int. Cl. G11B 19/00

(52) U.S. Cl. 369/47.5; G9B/19

(57) ABSTRACT

A recording method including: recording on a write-once-read-many optical medium capable of recording and reproducing with a blue laser by CAV, ZCLV, or PCAV, wherein a laser emission pattern including a recording pulse comprises two or more different levels of recording power, and a laser emission time standardized by the laser emission pattern and reference clock is fixed regardless of a recording linear velocity.

### TECHNICAL FIELD

The present invention relates to a recording method for a write-once-read-many optical recording medium such as a Blu-ray disc and HD-DVD disc capable of recording and reproducing with a blue laser, and a write-once-read-many optical recording medium suitable for the recording method.

### BACKGROUND ART

Recently, in accordance with improvement of recording capacity and high density of an recording medium, write-once-read-many optical recording media having an ultra-high density, and capable of recording and reproducing at laser wavelengths of blue laser or shorter have been developed and standardized.

Conventional methods for controlling the rotational speed of an optical recording medium are generally classified into two systems: CLV (Constant Linear Velocity); and CAV (Constant Angular Velocity). Additionally, the methods include ZCLV (Zone CLV) and PCAV (Partial CAV): ZCLV is a modification of CLV in which an optical recording medium is divided into a plurality of zones depending on a radial position from the inner tracks to the outer tracks of a medium and each zone is subjected to recording with CLV; and PCAV performs recording by CAV in a certain zone from the inner tracks of a medium, and by CLV in the subsequent zones to the outer tracks of the medium.

In CLV, the rotational speed of the medium is so controlled that the number of rotations is inversely proportional to the radial distance of the track to ensure a constant linear velocity in the track direction, and information is recorded at a constant clock frequency. Therefore, the rotational speed of the medium should be varied, and a larger running torque is needed to vary the speed of a spindle motor which drives the medium to rotate. As a result, a motor of high cost and large power consumption is required, however, increased power consumption is not preferred particularly when recording on an optical recording medium is performed in an apparatus driven with a battery, such as a notebook-size personal computer. Additionally, the speed of the spindle motor changes while seeking, and an access time increases by an amount corresponding to the time it takes before the speed change of the spindle motor is completed.

Meanwhile, in CAV, recording is performed by increasing the recording clock frequency from the inner tracks to the outer tracks of a medium in a manner proportional to the radial position of the track. In this case, the recording linear density is kept constant, because the recording linear velocity is smaller in the inner tracks while larger in the outer tracks. Thus, in contrast to CLV, the speed of a spindle motor needs not to be changed and a smaller torque, less expensive motor can be used. An access time can be shorter because of absence of waiting time for speed change during seeking.

However, upon recording on a typical optical recording medium, a laser power and a recording pulse waveform during recording are optimized at a specific recording linear velocity. When the recording linear velocity is varied, the condition of recording marks is changed and a jitter property may be adversely affected, specifically, a higher jitter value.

As a solution for the above problems, Patent Literature 1 proposes a method in which optimum recording powers are obtained for at least two positions in an entire recordable area of an optical recording medium at the same recording linear velocity, and then the optimum recording powers for all recording linear velocities are obtained by an interpolation routine for recording.

However, in an optical recording medium which is recorded and reproduced by a blue laser, smaller marks should be precisely recorded. Thus, the above-mentioned method is inadequate.

Moreover, Patent Literature 2 proposes a method in which a pulse height and pulse width of a recording signal are changed according to the recording linear velocity to optimize the recording mark shape for recording.

However, Patent Literature 2 provides no quantitative consideration as to how to change the recording pulse sequence.

Patent Literature 3 proposes a method in which the ratios of recording power, heating pulse width, and heat pulse duty in a successive multipulse part between a desired recording linear velocity and a minimum recording linear velocity are quantitatively changed to perform recording.

However, in the case of an optical recording medium designed for blue-laser wavelength, multipulse recording encounters a limitation in the recording speed in view of the rise-time and fall-time of the laser.

Moreover, when a recording pulse is varied, it takes additional time to perform recording because an optimum recording power is determined for each recording pulse.

Patent Literature 1 Japanese Patent Application Laid-Open (JP-A) No. 5-225570

Patent Literature 2 Japanese Patent Application Laid-Open (JP-A) No. 10-106008

Patent Literature 3 Japanese Patent Application Laid-Open (JP-A) No. 2001-76341

### DISCLOSURE OF INVENTION

The present invention has been accomplished in view of the foregoing circumstances, and an object of the present invention is to solve the above-problems in the prior art and to achieve the following object.

The present invention has been accomplished in view of the prior art, and an object of the present invention is to provide a recording method that enables formation of recording marks with high precision at all recording linear velocities on a write-once-read-many optical recording medium capable of recording and reproducing with a blue laser by CAV, ZCLV, or PCAV, and that enables short-time recording by performing recording without changing a laser emission time standardized by a laser emission pattern and a reference clock, and a write-once-read-many optical recording medium suitable for the recording method.

These problems are solved by the invention of the following <1> to <10> (hereinafter, also referred to as the first to tenth embodiments of the present invention).

<1> A recording method including: recording on a write-once-read-many optical medium capable of recording and reproducing with a blue laser by CAV, ZCLV, or PCAV, wherein a laser emission pattern including a recording pulse comprises two or more different levels of recording power, and a laser emission time standardized by the laser emission pattern and reference clock is fixed regardless of a recording linear velocity.
<2> The recording method according to <1>, wherein the laser emission pattern including a recording pulse comprises a first recording power Pw and a second recording power Pm, and satisfies the following condition at recording linear velocities corresponding to 2× to 4×:

Pw>Pm, 0.66≦Pm/Pw≦0.79.

<3> The recording method according to <1>, wherein the laser emission pattern including a recording pulse comprises a first recording power Pw and a second recording power Pm, and satisfies the following condition at recording linear velocities corresponding to 2× to 5×:

Pw>Pm, 0.63≦Pm/Pw.

<4> The recording method according to any of <1> to <3>, wherein recording is performed while increasing the recording power with increasing recording linear velocity.
<5> The recording method according to <4>, wherein recording is performed while multiplying the recording power by a constant number with increasing recording linear velocity.
<6> The recording method according to one of <4> and <5>, wherein recording is performed while determining a recording power for each recording linear velocity on the basis of first information of the recording power obtained by OPC and second information of an amount of the recording power to be increased according to an increase in the recording linear velocity, the second information being pre-stored in a read-in area or BCA area (Burst Cutting area).
<7> The recording method according to any one <1> to <6>, wherein recording is performed on a write-once-read-many optical recording medium having a recording layer comprising an inorganic material.
<8> The recording method according to <7>, wherein the recording layer primarily comprises bismuth oxide.
<9> A write-once-read-many optical recording medium including: information indicating that recording is possible by CAV, ZCLV, or PCAV, and information of a laser emission time standardized by a laser emission pattern and reference clock, the laser emission time being fixed regardless of a recording linear velocity, the laser emission pattern including a recording pulse having two or more different levels of recording power, wherein each information is pre-stored in a read-in area or BCA area, and the write-once-read-many optical recording medium is suitable for the recording method according to any one of <1> to <8>.
<10> A write-once-read-many optical recording medium including: information indicating that recording is possible by CAV, ZCLV, or PCAV, and information of an amount of a recording power to be increased according to an increase in a recording linear velocity, wherein each information is pre-stored in a read-in area or BCA area, and the write-once-read-many optical recording medium is suitable for the recording method according to any one of <4> to <8>.

### BRIEF DESCRIPTION OF DRAWINGS

FIG. 1A is an example of an explanatory drawing of CLV, showing the number of rotations of a medium.

FIG. 1B is an example of an explanatory drawing of CLV, showing a recording linear velocity.

FIG. 1C is an example of an explanatory drawing of CLV, showing a clock frequency.

FIG. 2A is an example of an explanatory drawing of CAV, showing the number of rotations of a medium.

FIG. 2B is an example of an explanatory drawing of CAV, showing a recording linear velocity.

FIG. 2C is an example of an explanatory drawing of CAV, showing a clock frequency.

FIG. 3A is an example of an explanatory drawing of ZCLV, showing the number of rotations of a medium.

FIG. 3B is an example of an explanatory drawing of ZCLV, showing a recording linear velocity.

FIG. 3C is an example of an explanatory drawing of ZCLV, showing a clock frequency.

FIG. 4A is an example of an explanatory drawing of PCAV, showing the number of rotations of a medium.

FIG. 4B is an example of an explanatory drawing of PCAV, showing a recording linear velocity.

FIG. 4C is an example of an explanatory drawing of PCAV, showing a clock frequency.

FIG. 5 shows an example of a multipulse laser emission pattern.

FIG. 6 shows an example of a laser emission pattern containing a castle type recording pattern.

FIG. 7 shows an example of a laser emission pattern containing a L-shaped type recording pattern.

FIG. 8 shows an example of a laser emission pattern containing a reverse L-shaped type recording pattern.

FIG. 9 shows an example of a laser emission pattern containing a block type recording pattern.

FIG. 10 shows an example of Pm, Pw, Pm/Pw and jitter when recording is performed at recording linear velocities corresponding to 2× to 4× without changing a recording pulse.

FIG. 11 shows an example of Pm, Pw, Pm/Pw and jitter when recording is performed at recording linear velocities corresponding to 2× to 5× without changing a recording pulse.

FIG. 12 shows an example of a cross-sectional view of a write-once-read-many optical recording medium of the present invention.

FIG. 13A shows a waveform diagram of a laser emission pattern used in Examples 1 to 5.

FIG. 13B shows each parameter of a laser emission pattern used in Examples 1 to 5.

FIG. 14A shows a waveform diagram of a laser emission pattern used in Examples 6 and 7.

FIG. 14B shows each parameter of a laser emission pattern used in Examples 6 and 7.

FIG. 15A shows a waveform diagram of a laser emission pattern used in Examples 8 and 9.

FIG. 15B shows each parameter of a laser emission pattern used in Examples 8 and 9.

FIG. 16A shows a waveform diagram of a laser emission pattern used in Examples 10 and 11.

FIG. 16B shows each parameter of a laser emission pattern used in Examples 10 and 11.

FIG. 17 shows a graph showing a recording power and a preheating power at each recording velocity used in Example 6.

FIG. 18 shows a graph showing a recording power and a preheating power at each recording velocity used in Example 7.

### BEST MODE FOR CARRYING OUT THE INVENTION

Hereinafter, the present invention will be explained in detail.

A recording system relating to the recording method of the present invention will be explained with reference to the drawings.

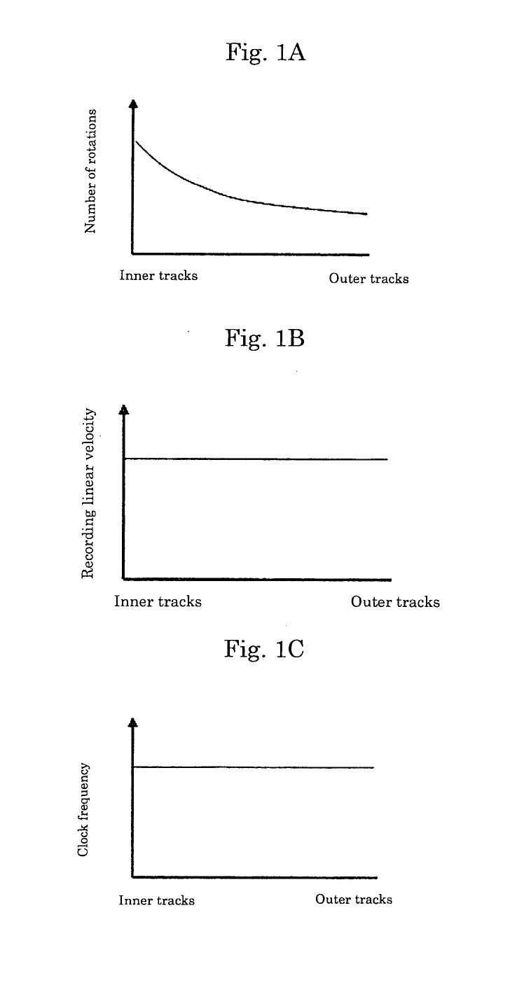

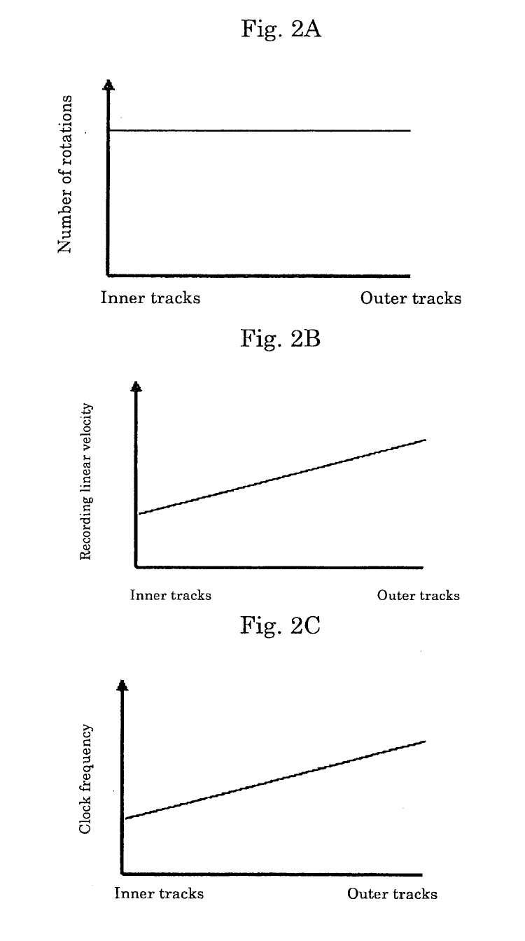

FIGS. 1A, 1B and 1C are explanatory drawings of CLV, and FIGS. 2A, 2B and 2C are explanatory drawings of CAV. In each figure, A, B and C respectively show changes in the number of rotations, recording linear velocity, and clock frequency from the inner tracks to the outer tracks of a medium.

In CLV the rotational speed of the medium is so controlled that the number of rotations is inversely proportional to the radial distance of the track to ensure a constant linear velocity in the track direction, and information at a constant clock frequency is recorded. Therefore, the rotational speed of the medium should be changed, and a larger running torque is needed to change the speed of a spindle motor which drives the medium to rotate. As a result, a motor of high cost and large power consumption is required.

When an optical recording medium is recorded by means of a slim optical recording device built in, for example, a notebook-sized personal computer, a small spindle motor should be used, and the number of rotations thereof is limited. Thus, in CLV, the recording linear velocity cannot be sufficiently increased in the outer tracks of the medium and an access time takes longer because the speed of the spindle motor changes during seeking.

Meanwhile, in CAV recording is performed by increasing the recording clock frequency from the inner tracks to the outer tracks of a medium in a manner proportional to the radial position of the track. In this case, the recording linear density is kept constant, because the recording linear velocity is smaller in the inner tracks while larger in the outer tracks. Thus, in contrast to CLV, the speed of a spindle motor needs not to be changed and a smaller torque, less expensive motor can be used. An access time can be shorter because of absence of waiting time for speed change during seeking.

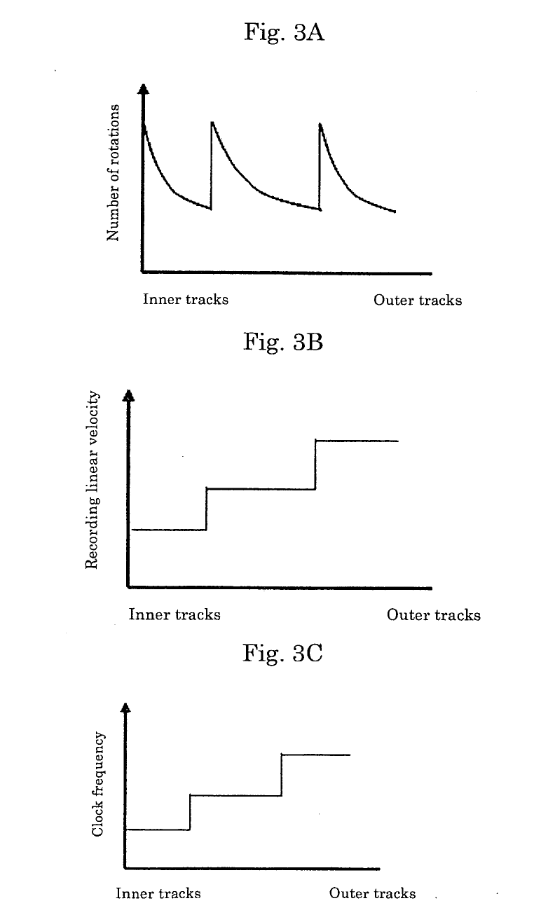

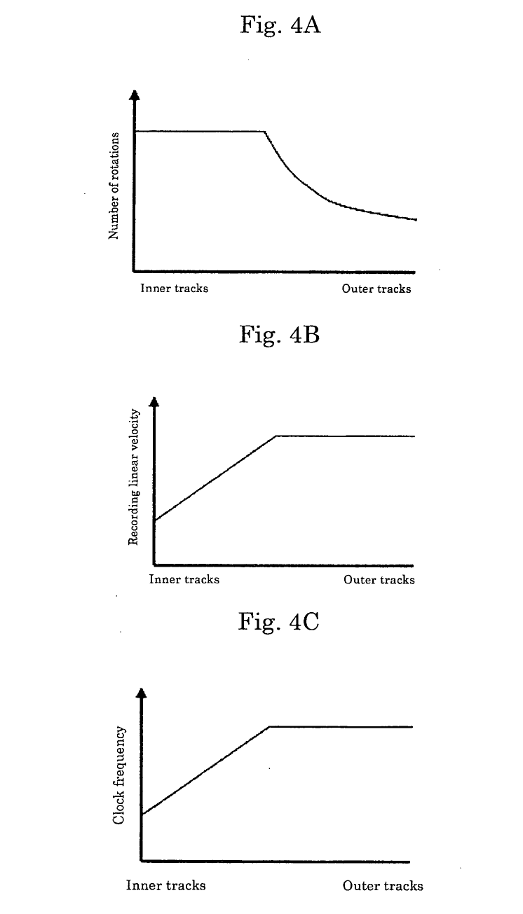

FIGS. 3A, 3B and 3C are explanatory drawings of ZCLV, and FIGS. 4A, 4B and 4C are explanatory drawings of PCAV. In each figure, A, B and C respectively show changes in the number of rotations, recording linear velocity, and clock frequency from the inner tracks to the outer tracks of a medium.

ZCLV is a system in which a disc is divided into a plurality of zones depending on a radial position and each zone is subjected to recording by CLV, and the number of rotations of the disc, the recording linear velocity, and the clock frequency in each zone are as shown in FIGS. 3A, 3B and 3C. PCAV is a system in which recording is performed from the inner tracks to a certain radial position of a disc by CAV and in the rest of the disc to the outer tracks by CLV, and the number of rotations thereof, the recording linear velocity, and the clock frequency in each zone are as shown in FIGS. 4A, 4B and 4C.

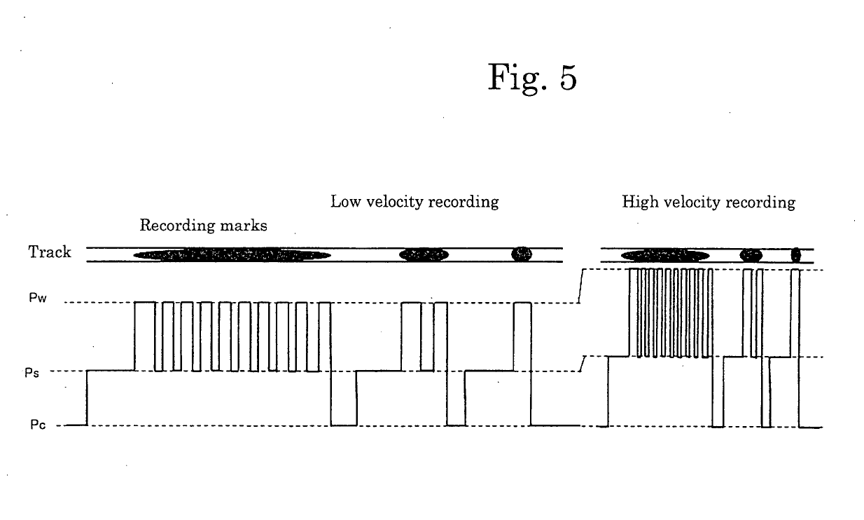

FIGS. 5 to 7 are explanatory drawings showing laser emission patterns (write strategy) when recording.

FIG. 5 shows an example of a so-called multipulse laser emission pattern. A laser output is repeatedly increased and decreased, so that the end of the recording mark will not be thicken (formed in a so-called tear-drop-shaped mark). However, it takes approximately 1 nsec to 2 nsec for rise-time and fall-time in a laser used for a general recording and reproducing apparatus.

On the other hand, when the recording linear velocity is increased in multipulse recording, the intervals of heating pulses become narrower as shown in the right side of FIG. 5. In such a condition, the recording power is needed to be larger, and in addition, recording sensitivity may become poor unless there is a certain size of space between adjacent heating pulses of the multipulse part. Thus, when the intervals between heating pulses are gradually reduced to a level shorter than the rise-time and fall-time of laser with increasing recording linear speed, multipulse recording will fail.

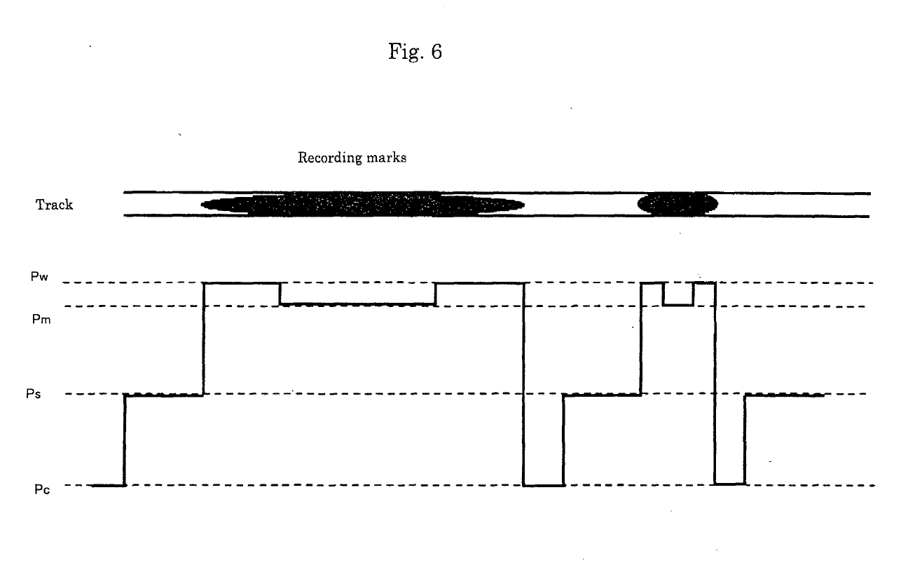

FIG. 6 shows an example of a so-called castle type laser emission pattern, where a larger recording power (Pw) is used in the front and rear of the recording pulse, and somewhat lesser power (Pm) is used in the middle of the recording pulse without fluctuating its power level, so that the mark does not broaden and high-sensitivity recording is achieved even at high velocities.

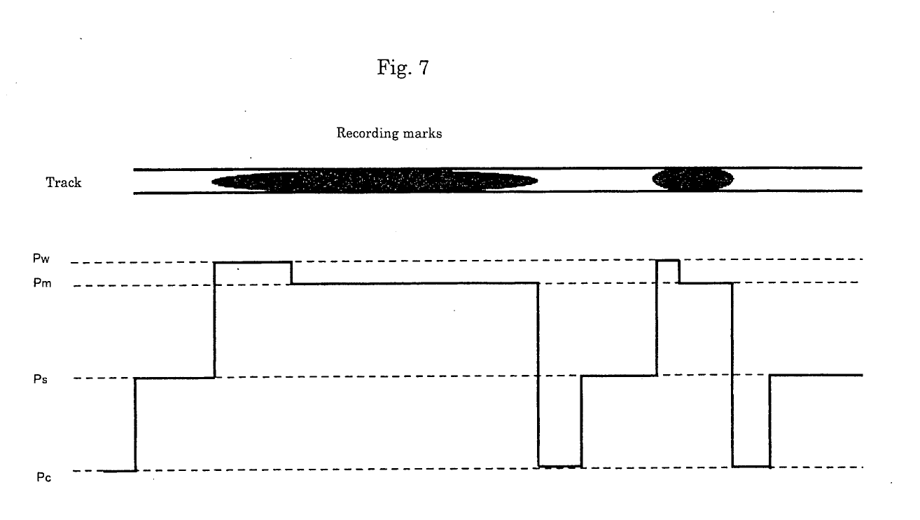

FIG. 7 shows an example of a so-called L-shaped type laser emission pattern, where a larger recording power (Pw) is used in the front of the recording pulse and somewhat lesser power (Pm) is used thereafter.

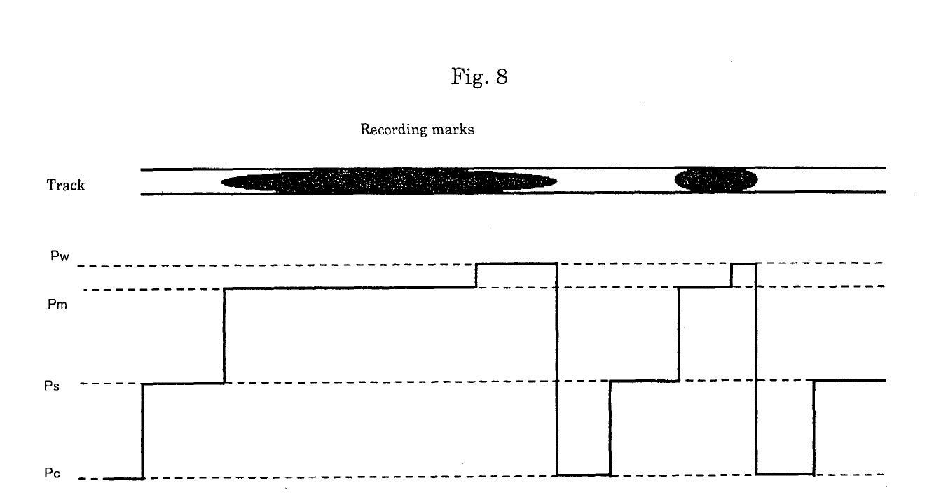

FIG. 8 shows an example of a reverse L-shaped type laser emission pattern, where a larger recording power (Pw) is used in the end of the recording pulse and somewhat lesser power (Pm) is used therebefore.

These types of recording pulse can achieve recording at high velocities without having to fluctuate the pulse in the middle of the recording pulse, as can the castle type recording pulse, making high-sensitivity recording at high velocities possible.

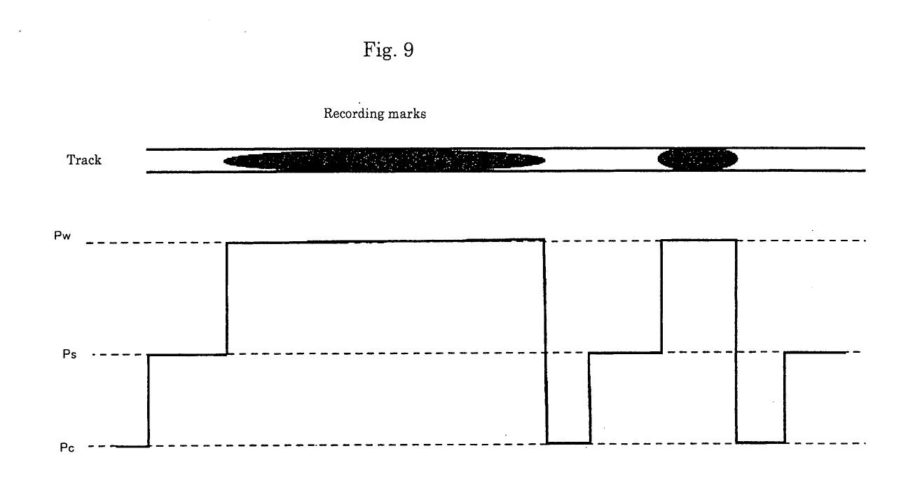

FIG. 9 shows an example of a so-called block type (rectangular wave) laser emission pattern, and high-sensitivity recording can be realized by using a recording pulse having a larger recording power (Pw). A long mark such as 8 T mark may possibly broaden at its end in the case of the block type recording pulse, but shorter marks such as 2 T and 3 T marks, which are more important in confirming the recording quality, are often recorded with a rectangular wave in high linear velocity recording.

The recording pulses such as a castle, L-shaped, and reverse L-shaped and block type (rectangular wave) may be combined to perform recording, depending on the size of the recording mark.

The first embodiment of the present invention includes the step of recording on a write-once-read-many optical recording medium capable of recording and reproducing with a blue laser by CAV, ZCLV, or PCAV wherein a laser emission pattern including a recording pulse comprises two or more different levels of recording power, and a laser emission time standardized by the laser emission pattern and reference clock is fixed regardless of a recording linear velocity. Examples of the recording pulses comprising two or more different levels of recording power include the castle type recording pulse and L-shaped type recording pulse.

The laser emission time standardized by the laser emission pattern and reference clock is fixed regardless of a recording linear velocity which means that a parameter of the recording strategy is not changed although the linear velocity is changed.

Generally, a parameter of the recording strategy is set at each recording linear velocity, and a recording condition should be optimized when the recording strategy is changed. Thus, it takes additional time to perform recording for optimization.

On the other hand, the present invention can perform recording for short time because of performing recording without changing a parameter.

In the second embodiment of the present invention, the recording pulse contains a first recording power Pw and a second recording power Pm, where Pw>Pm, and examples thereof include the above-described castle type and L-shaped type recording pulses. However, the rectangular pulse waveform is frequently used when short marks such as 2 T and 3 T marks are recorded.

Then, by using these recording pulses, a recording pulse can be generated even at high recording linear velocities and high recording channel frequencies. Additionally, the recording power in the middle of the recording mark is made smaller than the recording power in the front of the recording mark when a long mark is recorded, so that the end of the recording mark does not broaden (formed in a so-called tear-drop-shaped mark) and an excellent recording mark with low jitter can be formed.

When a recording pulse having the first recording power Pw and the second recording power Pm, which satisfy the condition 0.66≦Pm/Pw≦0.79, is used, such excellent recording properties as high quality and low jitter can be obtained even by using the same recording pulse at recording linear velocities corresponding to 2× to 4×, specifically, 2 times to 4 times the standard recording linear velocity.

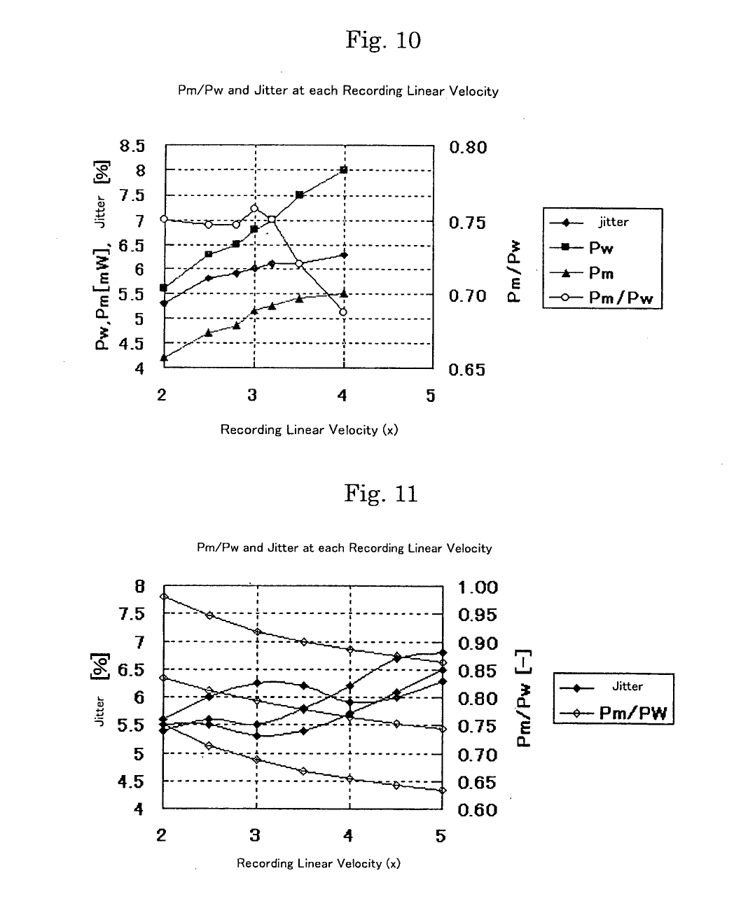

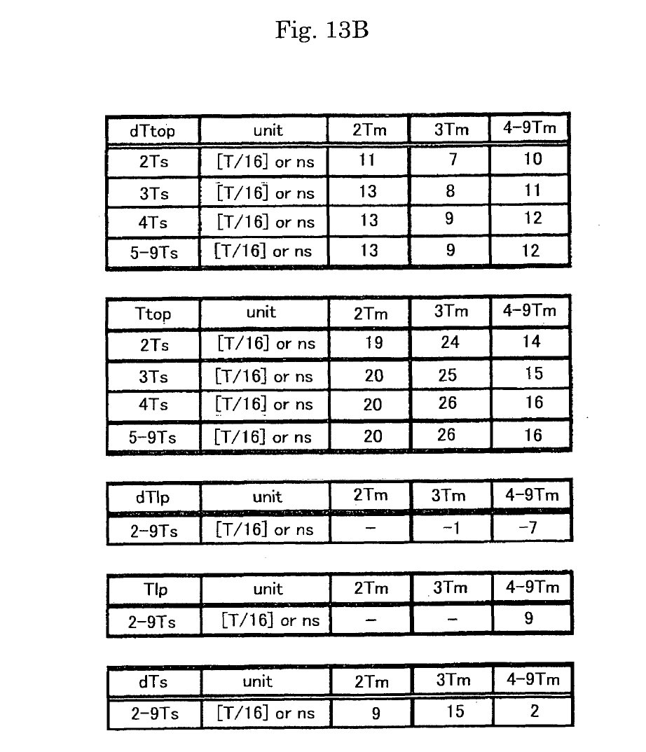

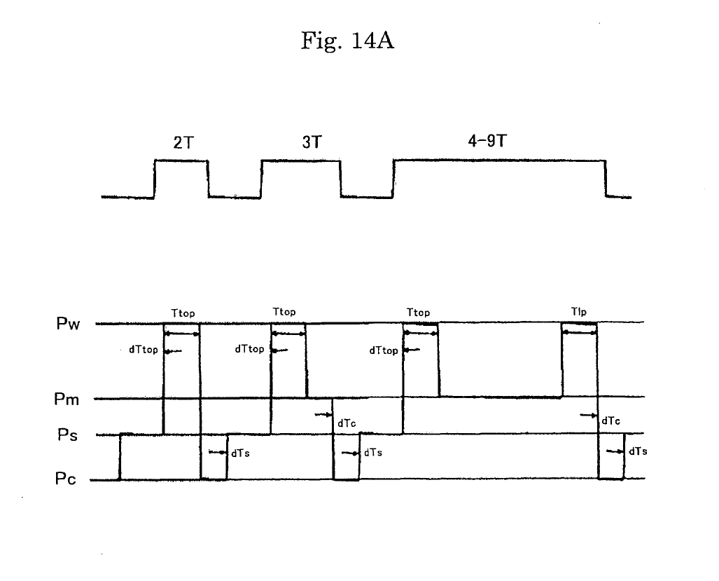

FIG. 10 shows Pm, Pw, Pm/Pw and jitter values when recording has been performed, on a write-once-read-many optical recording medium having the same layer configuration as that in Example 1 described hereinafter, at recording linear velocities corresponding to 2× to 4× by using the laser emission pattern shown in FIGS. 13A and 13B without changing the recording pulse. When Pm/Pw is in a certain range, an excellent recording quality with low jitter can be obtained without changing the recording pulse at recording linear velocities corresponding to 2× to 4×. When Pm/Pw is less than 0.65, a power is not enough to record the middle of the recording mark, it is difficult to form the recording mark, and a jitter value becomes high. When Pm/Pw is 0.80 or more, heat is accumulated in the middle of the recording mark and the recording mark broadens in radial directions, and then crosstalk occurs between adjacent tracks, and the jitter value increases.

The second embodiment of the present invention defines the condition for obtaining the recording property of high quality with low jitter using the same recording pulse at recording linear velocities corresponding to 2× to 4×. The third embodiment of the present invention defines the condition for obtaining the recording property of high quality with low jitter using the same recording pulse at recording linear velocities corresponding to 2× to 5×.

Specifically, the third embodiment of the present invention satisfies the following condition: Pw>Pm and 0.63≦Pm/Pw.

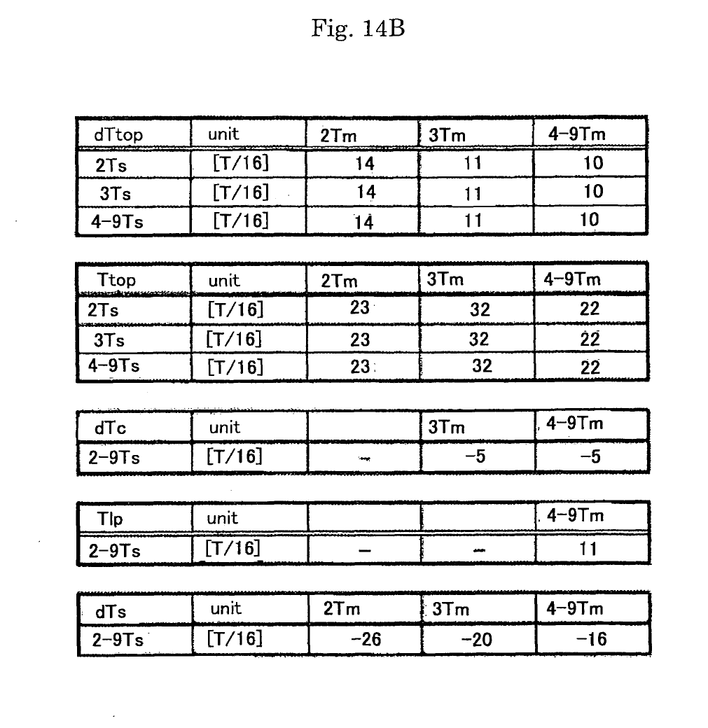

FIG. 11 shows Pm/Pw and jitter values when the recording has been performed, on a write-once-read-many optical recording medium having the same layer configuration as that in Example 6 described hereinafter, without changing the recording pulse at recording linear velocities corresponding to 2× to 5× using the laser emission pattern shown in FIGS. 14A and 14B. When Pm/Pw is in a certain range, an excellent recording quality with low jitter can be obtained without changing the recording pulse at the recording linear velocities corresponding to 2× to 5×. When Pm/Pw is less than 0.63, a power is not enough to record the middle of the recording mark, it is difficult to form recording marks, and a jitter value becomes high.

The reason that the conditions of Pm/Pw are different between the second and third embodiments of the present invention is that the ranges of the recording linear velocities are different and thus the laser emission pattern should be changed, and that the recording power (Pm) is slightly changed in the valley part of the castle strategy. The third embodiment does not define the maximum value of Pm/Pw in spite of the fact that heat is accumulated and the end of the recording mark easily broadens as the pulse wave becomes closer to a rectangular wave, or Pm/Pw approaches 1, because this heat accumulation can be suppressed by the fine control of the recording strategy, i.e., the control of the height of the crests located in the front and rear, and the control of the cooling time after recording. For example, recording can be performed at 2× in Examples 6 to 7 in Table 2, even though Pm/Pw is 0.98.

In the fourth embodiment of the present invention, recording is performed while increasing the recording power according to an increase in the recording linear velocity. For example, in the fifth embodiment of the present invention, recording is performed while multiplying the recording power by a constant number according to the increase in the recording linear velocity. Thus, sufficiently high recording quality can be obtained, and an optimum recording power is obtained at several recording linear velocities and approximated, and then the optimum recording power can be obtained at each recording linear velocity. As a result, recording can be performed with the optimum recording power at each recording linear velocity without obtaining the optimum recording power by a running OPC during recording, and then a necessary time for recording can be considerably shortened and recording marks can be formed with high accuracy.

In the sixth embodiment of the present invention, the recording power at each recording linear velocity is determined for recording on the basis of information of the recording power obtained by OPC (Optimum Power Control) and information of the amount of the recording power to be increased according to an increase in the recording linear velocity, prerecorded in a read-in area or BCA area (Burst Cutting area). Thus, although the linear velocity in the outer tracks and that in the inner tracks of a medium are different, the optimum recording power at a linear velocity of the outer tracks can be obtained without performing OPC or running OPC in the outer tracks, on the basis of the result of OPC performed at a certain linear velocity in the inner tracks. As a result, for example, upon recording with the CAV system using a slim recording drive which cannot perform high linear velocity recording with the inner track OPC, recording can be performed at an optimum recording power in the subsequent and outer tracks using the result of the inner track OPC, whereby necessary time for recording can be considerably shortened.

In the seventh embodiment of the present invention, recording is performed on a write-once-read-many optical recording medium having a recording layer containing an inorganic material. The inorganic material of the recording layer offers excellent recording properties at high recording linear velocities, thus, a broad recording margin can be obtained along with an increase in the recording linear velocity.

In the eighth embodiment of the present invention, recording is performed on a write-once-read-many optical recording medium having a recording layer made of material primarily containing bismuth oxide among other inorganic materials. Here, the “primarily containing” means that 50 mass % or more of a component makes up the entire recording layer material. The recording layer primarily containing bismuth oxide offers excellent recording properties at high recording linear velocities, so that it can achieve excellent optical properties such as a light absorption ability and recording ability, and a broad recording margin can be obtained with respect to the recording linear velocity.

Additionally, the recording method of the present invention can be used on a write-once-read-many optical recording medium containing phase change recording materials or dyes as the materials of the recording layer.

In the ninth embodiment of the present invention, a write-once-read-many optical recording medium stores in a read-in area or BCA area information indicating that recording is possible by CAV, ZCLV or PCAV, and information of a fixed laser emission time standardized by the laser emission pattern and the reference clock regardless of the recording linear velocity, wherein the laser emission pattern including a recording pulse contains two or more different levels of recording power.

Therefore, it can be determined which system can be adopted for recording, by reading these information before recording. Recording of information in the read-in area or BCA area can be performed by conventional methods such as formation of pits.

In the tenth embodiment of the present invention, a write-once-read-many optical recording medium pre-stores in the read-in area or BCA area information indicating that recording is possible by CAV, ZCLV or PCAV, and information of the amount of recording power to be increased according to an increase in the recording linear velocity according to the fourth and fifth embodiments of the present invention. Therefore, the amount of the recording power to be increased can be set in accordance with these information, and thus, there is no need to obtain an optimum recording power by trial writing when the recording linear velocity has been changed.

The write-once-read-many optical recording medium suitable for the recording method of the present invention preferably has the following configurations, however, they are not particularly limited thereto.

(a) Substrate, recording layer primarily containing bismuth oxide, upper coating layer, and reflective layer
(b) Substrate, under coating layer, recording layer primarily containing bismuth oxide, upper coating layer, and reflective layer
(c) Cover layer, recording layer primarily containing bismuth oxide, upper coating layer, reflective layer, and substrate
(d) Cover layer, under coating layer, recording layer primarily containing bismuth oxide, upper coating layer, reflective layer, and substrate

Further, on the basis of the above configurations, a configuration of layers may be formed in a multi-layered configuration. For example, when formed in multi-layered based on the configuration of (a), it may has a configuration as follows: Substrate, recording layer primarily containing bismuth oxide, upper coating layer, reflective layer or translucent layer, binder layer, recording layer primarily containing bismuth oxide, upper coating layer, reflective layer, and substrate.

Additionally, the write-once-read-many optical recording medium may be configured such that a substrate and a protective substrate are disposed on both sides of the optical recording medium.

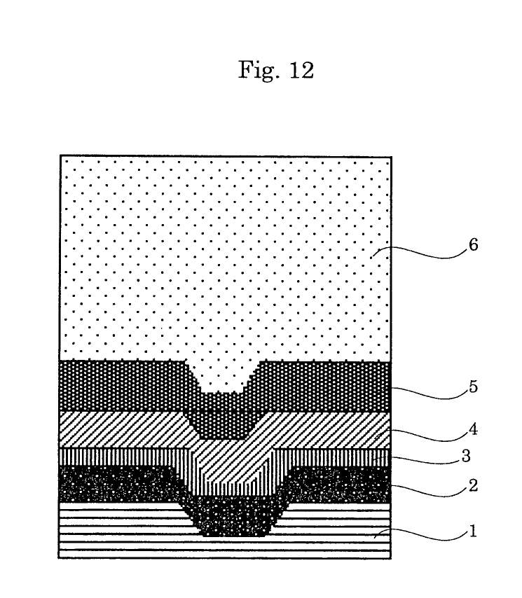

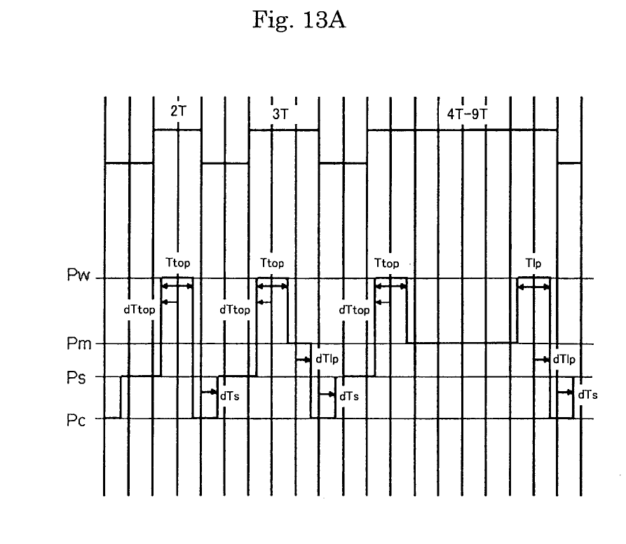

FIG. 12 shows an example of a cross-sectional view of a layer configuration suitably applied to the write-once-read-many optical recording medium of the present invention, and a reflective layer 5, an upper coating layer 4, a recording layer 3, an under coating layer 2, and a cover layer 1 are disposed on a substrate 6 in this order. The recording layer 3 primarily contains bismuth oxide.

Next, details of each layer will be explained.

### [Substrate]

Materials for the substrate are not particularly limited, as long as they have excellent thermal and machine properties, and when recording and reproducing is performed from the side of the substrate or through the substrate, they also have excellent light transmission properties.

Specifically, examples thereof include polycarbonates, polymethyl methacrylates, amorphous polyolefins, cellulose acetates, polyethylene terephthalate, of which polycarbonates and amorphous polyolefins are preferable. The thickness of the substrate varies depending on application and is not particularly limited. A guide groove and guide pit for tracking and further preformat such as address signal may be formed on the surface of the substrate.

### [Protective Substrate]

The protective substrate should be transparent to a laser beam when the laser beam is applied from the protective substrate side. On the other hand, it may be or may not be transparent when used merely as a protective plate. Materials available for the protective substrate are exactly the same as the materials for the substrate.

### [Recording Layer]

The recording layer of the write-once-read-many optical recording medium of the present invention preferably contains inorganic recording materials, particularly, primarily contains bismuth oxide as described above.

Examples of the recording layers primarily containing bismuth oxide include, but not limited to, BiO-based thin layers formed by sputtering of Bi₂Oₓ as a target, BiFeO formed by sputtering of Bi₃Fe₅Oₓ as a target, BiBO formed by sputtering of Bi₂BOₓ as a target, BiAlO based thin layers formed by sputtering of Bi₃AlOₓ as a target, BiFeAlO formed by sputtering of Bi₃Fe₁Al₄Oₓ as a target, and BiBGeO formed by sputtering of Bi₂BGeOₓ as a target.

Specifically, examples of the recording layers primarily containing bismuth oxide include the RO films (where R represents Bi element), which have been proposed by the present applicant and disclosed in Japanese Patent Application Laid-Open (JP-A) Nos. 2005-108396 and 2005-161831 as follows:

(1) a RO film containing bismuth oxide
(2) a RO film containing bismuth and bismuth oxide
(3) a RO film, where R represents Bi and contains one or more elements selected from the group 4B, and when the composition is Biₐ4B_{b}O_{d}, where 4B represents an element from the group 4B and a, b, d represent relative proportions, the RO film containing bismuth oxide satisfies the following condition:

10≦a≦40, 3≦b≦20, 50≦d≦70

(4) a RO film containing one or more elements M selected from Al, Cr, Mn, In, Co, Fe, Cu, Ni, Zn and Ti, and when the composition is Biₐ4B_{b}M_{c}O_{d}, where 4B represents an element from the group 4B and a, b, c, d represent relative proportions, the RO film containing bismuth oxide satisfies the following condition:

10≦a≦40, 3≦b≦20, 3≦c≦20, 50≦d≦70

Examples of the elements from the group 4B in (3) and (4) include C, Si, Ge, Sn and Pb. Of these, Si and Ge are particularly preferred.

The above-described bismuth oxides are very effective as the materials of the recording layer to which a blue laser can be used, and have a low thermal conductivity and excellent durability, and thus easily provide high reflectance and transmittance (a result from a complex refractive index).

Particularly, Biₐ4B_{b}O_{d} or Biₐ4B_{b}M_{c}O_{d} is used for the recording layer, so that recording and reproducing properties and storage stability can be improved. The recording layer preferably has a thickness of 5 nm to 30 nm.

### [Under Coating Layer and Upper Coating Layer]

For the under coating layer and the upper coating layer, the following oxides and nonoxides are available: examples of the oxides include simple oxides such as Nb₂O₅, Sm₂O₃, Ce₂O₃, Al₂O₃, MgO, BeO, ZrO₂, UO₂, and ThO₂; silicate such as SiO₂, 2MgO.SiO₂, MgO.SiO₂, CaO.SiO₂, ZrO₂.SiO₂, 3Al₂O₃.2SiO₂, 2MgO.2Al₂O₃.5SiO₂, Li₂O.Al₂O₃.4SiO₂; double oxides such as Al₂ TiO₅, MgAl₂O₄, Ca₁₀(PO₄)₆(OH)₂, BaTiO₃, LiNbO₃, PZT [Pb (Zr, Ti)O₃], PLZT [(Pb, La)(Zr, Ti)O₃], and ferrite. Examples of the nonoxides include nitrides such as Si₃N₄, AlN, BN, and TiN; carbides such as SiC, B₄C, TiC, and WC; borides such as LaB₆, TiB₂, and ZrB₂; sulfides such as ZnS, CdS, and MoS₂; silicides such as MoSi₂; and carbons such as amorphous carbon, graphite, and diamond. A mixture of oxides and nonoxides such as ZnS and SiO₂ can be used as well.

Organic materials such as dyes and resins can also be used for the under coating layer and the upper coating layer.

Examples of the dyes include polymethine dyes, naphthalocyanine dyes, phthalocyanine dyes, squarylium dyes, chroconium dyes, pyrylium dyes, naphthoquinone dyes, anthraquinone (indanthrene) dyes, xanthene dyes, triphenylmethane dyes, azulene dyes, tetrahydrocholine dyes, phenanthrene dyes, triphenothiazine dyes, azo dyes, formazan dyes, and metal complexes of these compounds.

Examples of the resins include polyvinyl alcohols, polyvinyl pyrrolidones, cellulose nitrates, cellulose acetates, ketone resins, acrylic resins, polystyrene resins, urethane resins, polyvinyl butyrals, polycarbonates, and polyolefins. Each of these resins may be used alone or in combination with two or more.

A layer which contains the organic materials can be formed by means of vapor depositions, sputtering, CVD, i.e. Chemical Vapor Deposition, coating of a solvent or the like, which are commonly used.

When a coating method is used, the above-noted organic materials and the like are dissolved in an organic solvent and the solvent is coated by a commonly used coating method such as spraying, roller-coating, dipping, and spin-coating. Examples of typical organic solvents to be used include alcohols such as methanol, ethanol, and isopropanol; ketones such as acetone, methyl ethyl ketone, and cyclohexanone; amides such as N,N-dimethylacetoamide, and N,N-dimethylformamide; sulfoxides such as dimethylsulfoxide; ethers such as tetrahydrofuran, dioxane, diethyl ether, and ethylene glycol monomethyl ether; esters such as methyl acetate, and ethyl acetate; aliphatic halocarbons such as chloroform, methylenechloride, dichloroethane, carbon tetrachloride, and trichloroethane; aromatic series such as benzene, xylene, monochlorobenzene, and dichlorobenzene; cellosolves such as methoxyethanol, and ethoxyethanol; and hydrocarbons such as hexane, pentane, cyclohexane, and methylcyclohexane.

The under coating layer preferably has a thickness of 5 nm to 150 nm and the upper coating layer preferably has a thickness of 5 nm to 50 nm.

### [Reflective Layer]

For the reflective layer, light reflection materials having high reflectance against laser beams are used.

Examples of the light reflection materials include metals such as Al, Al—Ti, Al—In, Al—Nb, Au, Ag, and Cu, semimetals, and alloys thereof. Each of these materials may be used alone or in combination with two or more.

When a reflective layer is formed with an alloy, it is possible to prepare it by using an alloy as a target material by sputtering. Besides, it is also possible to form the reflective layer by tip-on-target method, for example, a Cu tip is placed on an Ag target material to form the reflective layer, and by cosputtering, for example, an Ag target and a Cu target are used.

It is also possible to alternately stack low-refractive index layers and high-refractive index layers using materials other than metals to form a multi-layered configuration for use as a reflective layer.

The reflective layer may be formed, for example, by sputtering, ion-plating, chemical vapor deposition, and vacuum deposition.

The reflective layer preferably has a thickness of 5 nm to 150 nm.

### [Protective Layer, Cover Layer or Overcoat Layer]

Materials for a protective layer, cover layer or overcoat layer to be formed on the reflective layer, an optically transparent layer or the like are not particularly limited, provided that the material can protect the reflective layer, the optically transparent layer or the like from external forces. Various organic materials and inorganic materials are used therefor.

Examples of the organic materials include thermoplastic resins, thermosetting resins, electron beam curable resins, and ultraviolet curable resins.

Examples of the inorganic materials include SiO₂, Si₃N₄, MgF₂, and SnO₂.

On the reflective layer and/or optically transparent layer and the like, the protective layer, cover layer or overcoat layer can be formed using a thermoplastic resin or thermosetting resin. First, the thermoplastic resin or thermosetting resin are dissolved in a suitable solvent to prepare a coating solution. Then, the coating solution is coated on the reflective layer and/or optically transparent layer and dried to thereby form the protective layer, cover layer or overcoat layer.

The protective layer, cover layer or overcoat layer using an ultraviolet curable resin can be formed by directly coating the ultraviolet curable resin on the reflective layer and/or optically transparent layer or dissolving the ultraviolet curable resin in a suitable solvent to prepare a coating solution and coating the coating solution on the reflective layer and/or optically transparent layer, and then irradiating ultraviolet ray to the coating solution to harden it.

For ultraviolet curable resins, for example, acrylate resins such as urethane acrylates, epoxy acrylates, and polyester acrylates can be used.

Each of these materials may be used alone and in combination with two or more and may be formed in not only a single layer but also in a multi-layered configuration.

For a method for forming the protective layer, coating methods such as spin-coating and casting, sputtering, chemical vapor deposition, or the like are used in the same manner as the recording layer. Of these the spin-coating is preferable.

The thickness of the protective layer is typically 0.1 μm to 100 μm, however it is preferably 3 μm to 30 μm in the present invention.

Further, a substrate may be disposed on the surface of the reflective layer or optically transparent layer. Two sheets of optical recording media may be laminated after arranging the reflective layer and optically transparent layer so as to face each other. In addition, an ultraviolet curable resin layer, an inorganic resin layer or the like may be formed on a mirror surface side of the substrate to protect the surface and to prevent dust or the like from attaching thereto.

### [Binder Layer]

A binder layer serves for binding the layers constituting the optical recording medium, for example, binding of the overcoat layer and a dummy substrate, and binding of the reflective layer and the recording layer, and any materials can be used, provided that the materials are not harmful to the properties required as the optical recording medium. The materials containing an ultra violet curable binder are preferable in terms of productivity.

The present invention can provide a recording method that enables formation of recording marks with high precision at all recording linear velocities on a write-once-read-many optical recording medium capable of recording and reproducing with a blue laser by CAV, ZCLV, or PCAV, and that enables short-time recording by performing recording without changing a laser emission time standardized by a laser emission pattern and a reference clock, and a write-once-read-many optical recording medium suitable for the recording method.

Moreover, the present invention can save troubles such as correction of the recording strategy form and trial writing associated with the correction, when recording is performed at recording linear velocities other than the standardized recording linear velocity.

### EXAMPLES

Hereinafter, with referring to Examples and Comparative Examples, the present invention will be explained in detail and the following Examples and Comparative Examples should not be construed as limiting the scope of the invention.

### Examples 1 to 5 and Comparative Examples 1 to 2

A write-once-read-many optical recording medium having a layer configuration as shown in FIG. 12 was prepared as follows:

On a substrate 6 made of polycarbonate having a thickness of 1.1 mm, a reflective layer 5 having a thickness of 35 nm and containing AlTi (1 mass % of Ti), an upper coating layer 4 having a thickness of 10 nm and containing ZnS and SiO₂ where ZnS:SiO₂=80:20 (mole %), a recording layer 3 having a thickness of 13 nm and containing Bi₂Boₓ, and an under coating layer 2 having a thickness of 10 nm and containing ZnS and SiO₂ where ZnS:SiO₂=80:20 (mole %) were formed in this order by sputtering.

Further, an ultraviolet curable resin (BRD807 manufactured by Nippon Kayaku Co., Ltd.) was coated on the under coating layer 2 by spin-coating so as to form a cover layer 1 having a thickness of 0.1 mm, thereby yielding a write-once-read-many optical recording medium having a thickness of approximately 1.2 mm.

In Bi₂Boₓ “x” represents an oxidation degree, and oxygen depletion might occur in the compound. In the recording layer, not only a stoichiometric oxide composition, but also a reductant which was an element to be oxidized were present.

The write-once-read-many optical recording medium was evaluated for recording and reproducing signals using an optical disc drive evaluation device ODU-1000 manufactured by Pulstec Industrial Co., Ltd. (wavelength=405 nm, numerical aperture NA=0.85).

Recording was performed using a laser emission pattern as shown in FIGS. 13A and 13B. FIG. 13A is a waveform diagram and FIG. 13B shows tables of each parameter. A recording linear velocity was set to a level corresponding to 2×, 3× and 4×.

A jitter conforming to a Blu-ray Disc Recordable standard was used as a measure for the recording quality for the evaluation of recording and reproducing signals.

The jitter specification was 6.5% or less, and a jitter of 6.5% or less was evaluated as A, and a jitter of more than 6.5% was evaluated as B.

The evaluation results are shown in Table 1.

TABLE 1

| | 2x | | | | 3x | | | | 4x | | | | |
|---|---|---|---|---|---|---|---|---|---|---|---|---|---|
| | Pw | Pm | | Jitter | Pw | Pm | | Jitter | Pw | Pm | | Jitter | Evalu- |
| | [mW] | [mW] | Pm/Pw | [%] | [mW] | [mW] | Pm/Pw | [%] | [mW] | [mW] | Pm/Pw | [%] | ation |
| Example 1 | 5.6 | 4.2 | 0.75 | 5.3 | 6.8 | 5.15 | 0.76 | 6.0 | 8 | 5.5 | 0.69 | 6.3 | A |
| Example 2 | 5.6 | 3.7 | 0.66 | 5.5 | 6.8 | 4.5 | 0.66 | 6.1 | 8 | 5.3 | 0.66 | 6.4 | A |
| Example 3 | 5.6 | 4.4 | 0.79 | 5.6 | 6.8 | 5.4 | 0.79 | 6.3 | 8 | 6.3 | 0.79 | 6.5 | A |
| Example 4 | 5.8 | 3.8 | 0.66 | 5.9 | 7 | 4.6 | 0.66 | 6.3 | 8.2 | 5.4 | 0.66 | 6.5 | A |
| Example 5 | 5.8 | 4.6 | 0.79 | 5.9 | 7 | 5.5 | 0.79 | 6.4 | 8.2 | 6.5 | 0.79 | 6.4 | A |
| Comparative | 5.6 | 3.6 | 0.64 | 5.8 | 6.8 | 4.4 | 0.65 | 6.5 | 8 | 5.2 | 0.65 | 7.1 | B |
| Example 1 | | | | | | | | | | | | | |
| Comparative | 5.6 | 4.5 | 0.80 | 6.0 | 6.8 | 5.5 | 0.81 | 6.6 | 8 | 6.4 | 0.80 | 7.5 | B |
| Example 2 | | | | | | | | | | | | | |

As shown in Table 1, Examples 1 to 5 satisfied the condition 0.66≦Pm/Pw≦0.79 and jitter was not greater than 6.5% at all recording linear velocities corresponding to 2× to 4×.

Meanwhile, in the case of Pm/Pw≦0.65 as in Comparative Example 1, jitter was 7.1% at 4×, a recording linear velocity where recording margin is small, and an adequate recording quality could not be obtained at all recording linear velocities in a laser emission time standardized by the same laser emission pattern and reference clock.

Moreover, 0.80≦Pm/Pw as in Comparative Example 2 resulted in a jitter of 6.6% at 3× and 7.5% at 4×, and adequate recording quality could not be obtained at all recording linear velocities in a laser emission time standardized by the same laser emission pattern and reference clock.

The recording quality was adversely affected in Comparative Examples because of failure to form satisfactory recording marks due to lack of heating power for forming recording marks, and an excess heating power that leaded to a large influence of crosstalk between adjacent tracks.

As can be seen from the above evaluation results, a recording mark-forming recording pulse contains a recording pulse containing a first recording power Pw and a second recording power Pm, where Pw>Pm, and when the relation of Pw and Pm satisfies the condition 0.66≦Pm/Pw≦0.79, recording can be performed in a laser emission time standardized by the same laser emission pattern and reference clock even when the recording linear velocity changes, whereby adequate recording quality with high accuracy can be obtained at all recording linear velocities corresponding to 2× to 4×.

Therefore, recording marks with high precision at all recording linear velocities can be formed on a write-once-read-many optical recording medium by applying CAV, ZCLV, or PCAV, in which the recording linear velocity changes from the inner tracks to the outer tracks.

### Examples 6 to 7

A write-once-read-many optical recording medium having a layer configuration as shown in FIG. 12 was prepared as follows:

On a substrate 6 made of polycarbonate having a thickness of 1.1 mm, a reflective layer 5 having a thickness of 50 nm and containing AgBi (Bi of 0.5 mass %), an upper coating layer 4 having a thickness of 15 nm and containing ZnS and SiO₂ where ZnS:SiO₂=80:20 (mole %), a recording layer 3 having a thickness of 16 nm and containing Bi₂BGeOₓ, and an under coating layer 2 having a thickness of 75 nm and containing ZnS and SiO₂ where ZnS:SiO₂=80:20 (mole %) were formed in this order by sputtering.

Further, an ultraviolet curable resin (R15 manufactured by Nippon Kayaku Co., Ltd.) was coated on the under coating layer 2 by spin-coating so as to form a cover layer 1 having a thickness of 0.1 mm, thereby yielding a write-once-read-many optical recording medium having a thickness of approximately 1.2 mm.

In Bi₂BGeOₓ “x” represents an oxidation degree, and oxygen depletion might occur in the compound. In the recording layer, not only a stoichiometric oxide composition, but also a reductant which was an element to be oxidized were present.

The write-once-read-many optical disc was evaluated for recording and reproducing signals using an optical disc drive evaluation device ODU-1000 manufactured by Pulstec Industrial Co., Ltd. (wavelength=405 nm, numerical aperture NA=0.85).

Recording was performed using a laser emission pattern as shown in FIGS. 14A and 14B. FIG. 14A is a waveform diagram and FIG. 14B shows tables of each parameter.

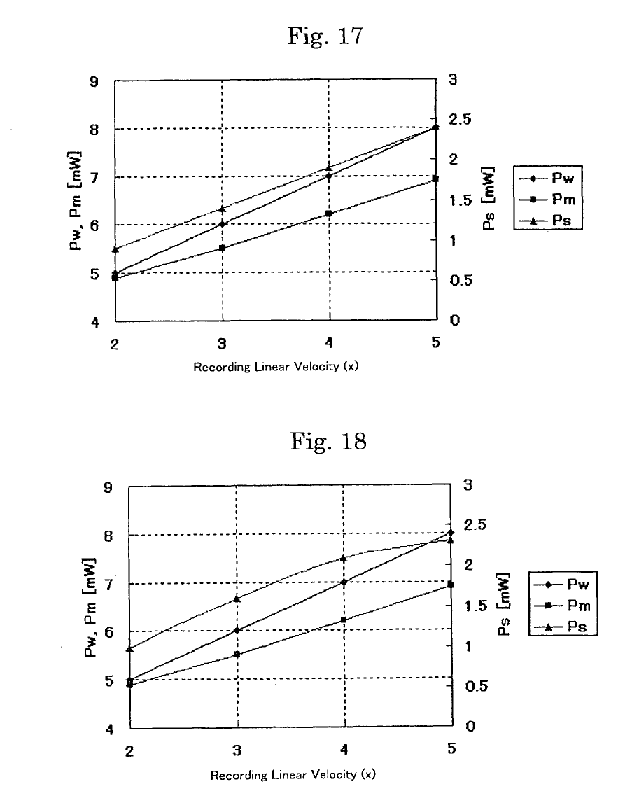

The recording linear velocity was set to a level corresponding to 2×, 3×, 4× and 5×, and in Example 6, recording powers Pw and Pm, and a preheating power Ps were set to increase linearly with increasing recording linear velocity as shown in FIG. 17, and in Example 7, only recording powers Pw and Pm were configured to increase linearly with increasing recording linear velocity as shown in FIG. 18.

A jitter conforming to a standard of a Blu-ray Disc Recordable Format ver1.2 was used as a measure of recording quality for evaluation of recording and reproducing signals.

The jitter specification was 7.0% or less, and a jitter of 7.0% or less was evaluated as A, and a jitter of more than 7.0% was evaluated as B.

The evaluation results are shown in Table 2.

### Examples 8 to 9 and Comparative Example 3

A blu-ray recordable disc for data LM-BR25D manufactured by Matsushita Electric Industrial Co., Ltd. was used as a write-once-read-many optical recording medium having a recording layer containing an inorganic material other than bismuth oxide, and evaluated for recording and reproducing signals using an optical disc drive evaluation device ODU-1000 manufactured by Pulstec Industrial Co., Ltd. (wavelength=405 nm, numerical aperture NA=0.85).

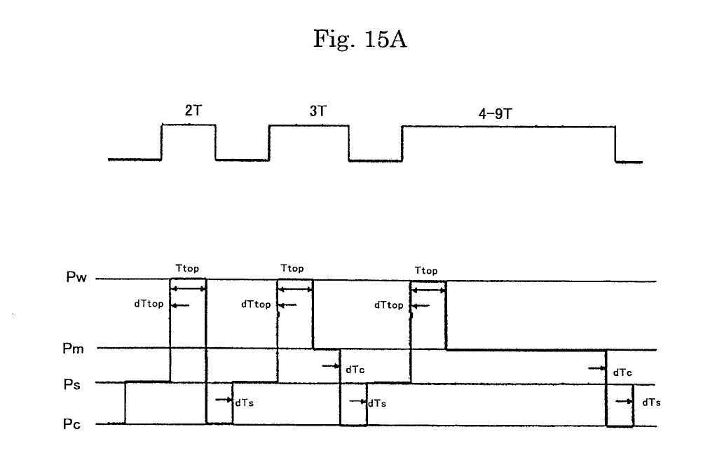

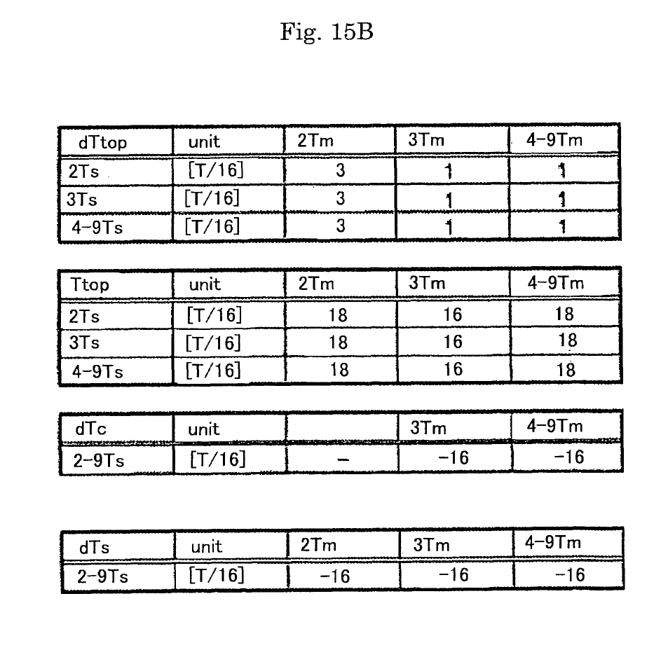

Recording was performed using a laser emission pattern shown in FIGS. 15A and 15B. FIG. 15A is a waveform diagram and FIG. 15B shows tables of each parameter. The recording linear velocity was set to a level corresponding to 2×, 3×, 4× and 5×, and recording powers Pw and Pm, and a preheating power Ps were configured to increase linearly with increasing the recording linear velocity.

The evaluation criteria for the recording and reproducing signals was the same as in Example 6. The evaluation results are shown in Table 2.

### Examples 10 to 11 and Comparative Example 4

A blu-ray recordable disc for data BNR25A manufactured by Sony corporation was used as a write-once-read-many optical recording medium having a recording layer containing an inorganic material other than bismuth oxide, and evaluated for recording and reproducing signals using an optical disc drive evaluation device ODU-1000 manufactured by Pulstec Industrial Co., Ltd. (wavelength=405 nm, numerical aperture NA=0.85).

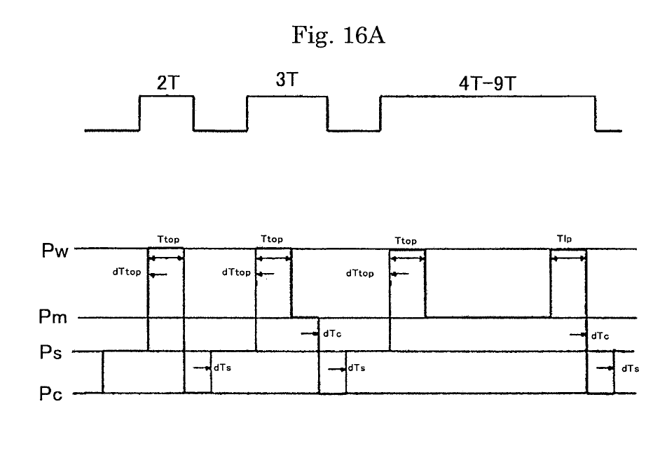

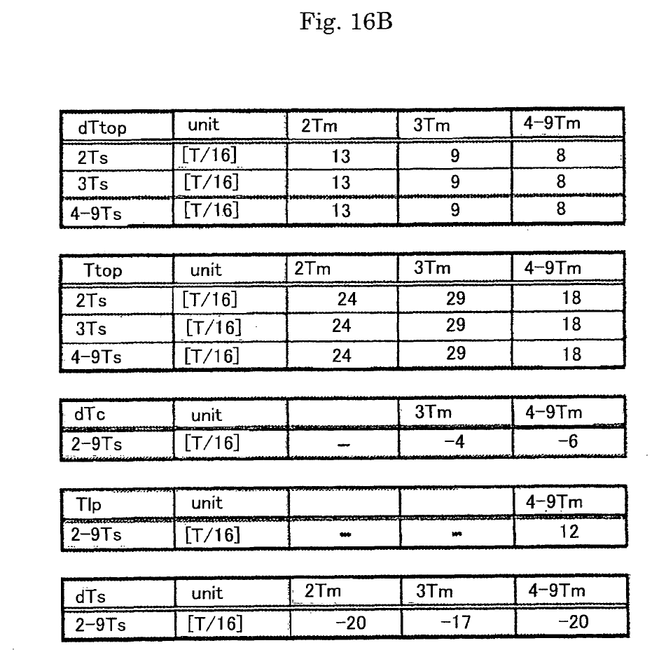

Recording was performed using a laser emission pattern shown in FIGS. 16A and 16B. FIG. 16A is a waveform diagram and FIG. 16B shows tables of each parameter.

The recording linear velocity was set to a level corresponding to 2×, 3×, 4× and 5×, and recording powers Pw and Pm, and a preheating power Ps were configured to increase linearly with increasing recording linear velocity.

The evaluation criteria for the recording and reproducing signals was the same as in Example 6. The evaluation results are shown in Table 2.

TABLE 2

| | 2x | | | | 3x | | | | 4x | | | | 5x | | | | |
|---|---|---|---|---|---|---|---|---|---|---|---|---|---|---|---|---|---|
| | Pw | Pm | | Jitter | Pw | Pm | | Jitter | Pw | Pm | | Jitter | Pw | Pm | | Jitter | Evalu- |
| | [mW] | [mW] | Pm/Pw | [%] | [mW] | [mW] | Pm/Pw | [%] | [mW] | [mW] | Pm/Pw | [%] | [mW] | [mW] | Pm/Pw | [%] | ation |
| Example 6 | 5 | 4.9 | 0.98 | 5.6 | 6 | 5.5 | 0.92 | 6.2 | 7 | 6.2 | 0.89 | 5.9 | 8 | 6.9 | 0.86 | 6.3 | A |
| Example 7 | 5 | 4.9 | 0.98 | 5.7 | 6 | 5.5 | 0.92 | 6.0 | 7 | 6.2 | 0.89 | 6.1 | 8 | 6.9 | 0.86 | 6.2 | A |
| Example 8 | 4.8 | 4 | 0.83 | 5.5 | 5.8 | 4.6 | 0.79 | 5.3 | 6.8 | 5.2 | 0.76 | 5.7 | 7.8 | 5.8 | 0.74 | 6.5 | A |
| Example 9 | 4.8 | 3.8 | 0.79 | 5.9 | 5.8 | 4.2 | 0.72 | 6.0 | 6.8 | 4.6 | 0.68 | 6.5 | 7.8 | 5 | 0.64 | 7.0 | A |
| Example 10 | 5.6 | 4.2 | 0.75 | 5.4 | 8 | 5.5 | 0.69 | 5.5 | 10.4 | 6.8 | 0.65 | 6.2 | 12.8 | 8.1 | 0.63 | 6.8 | A |
| Example 11 | 5.6 | 4.4 | 0.79 | 5.6 | 8 | 5.8 | 0.73 | 5.9 | 10.4 | 7.2 | 0.69 | 6.8 | 12.8 | 8.6 | 0.67 | 7.0 | A |
| Comparative | 4.8 | 4.2 | 0.88 | 5.8 | 5.8 | 4.4 | 0.76 | 5.7 | 6.8 | 4.6 | 0.68 | 6.5 | 7.8 | 4.8 | 0.62 | 7.4 | B |
| Example 3 | | | | | | | | | | | | | | | | | |
| Comparative | 5.6 | 4 | 0.71 | 5.9 | 8 | 5.3 | 0.66 | 5.8 | 10.4 | 6.6 | 0.63 | 7.0 | 12.8 | 7.9 | 0.62 | 7.5 | B |
| Example 4 | | | | | | | | | | | | | | | | | |

As can be seen from Table 2, Examples 6 to 11 satisfy the condition 0.63≦Pm/Pw, and the jitter was not greater than 7.0% at all recording linear velocities corresponding to 2× to 5×.

Meanwhile, in Comparative Examples 3 and 4, Pm/Pw was 0.62 at a recording linear velocity corresponding to 5× and the jitter was more then 7.0% (7.4% and 7.5%). Specifically, because a recording margin is small at a recording linear velocity corresponding to 5×, an adequate recording quality could not be obtained in the laser emission time standardized by the same laser emission pattern and reference clock as those at recording linear velocities corresponding to 2× to 4×.

As can be seen from Examples 6 and 7, an adequate recording quality could be obtained regardless of whether or not the preheating power Ps was linearly increased according to an increase in the recording linear velocity.

In Examples 8 and 9, a L-shaped type write strategy was used rather than a castle type write strategy as a laser emission pattern for recording of 4 T to 9 T marks, as shown in FIGS. 15A and 15B. An adequate recording quality was obtained for increased recording linear velocities, even though a recording pulse shape was changed.

In Examples 6 and 7, a recording layer material primarily containing bismuth oxide was used, and in Examples 8 to 11, an inorganic recording layer material containing other than bismuth oxide was used. In each Example an adequate recording quality was obtained for increased recording linear velocities.

As can be seen from the evaluation results described above, when the recording mark-forming recording pulse contains a recording pulse having a first recording power Pw and a second recording power Pm, where Pw>Pm, and when Pw and Pm satisfy the condition 0.63≦Pm/Pw, recording is possible in a laser emission time standardized by the same laser emission pattern and reference clock, even though the recording linear velocity changes, whereby an adequate recording quality with high precision could be obtained at all recording linear velocities corresponding to 2× to 5×. Therefore, recording marks with high precision at all recording linear velocities can be formed on a write-once-read-many optical recording medium by applying CAV, ZCLV, or PCAV, in which the recording linear velocity changes from the inner tracks to the outer tracks.

1. A recording method comprising:
recording on a write-once-read-many optical medium capable of recording and reproducing with a blue laser by CAV, ZCLV, or PCAV,
wherein a laser emission pattern including a recording pulse comprises two or more different levels of recording power, and a laser emission time standardized by the laser emission pattern and reference clock is fixed regardless of a recording linear velocity.

2. The recording method according to claim 1, wherein the laser emission pattern including a recording pulse comprises a first recording power Pw and a second recording power Pm, and satisfies the following condition at the recording linear velocities corresponding to 2× to 4×:
Pw>Pm, 0.66≦Pm/Pw≦0.79.

3. The recording method according to claim 1, wherein the laser emission pattern including a recording pulse comprises a first recording power Pw and a second recording power Pm, and satisfies the following condition at the recording linear velocities corresponding to 2× to 5×:
Pw>Pm, 0.63≦Pm/Pw.

4. The recording method according to, claim 1 wherein recording is performed while increasing the recording power with increasing the recording linear velocity.

5. The recording method according to claim 4, wherein recording is performed while multiplying the recording power by a constant number with increasing the recording linear velocity.

6. The recording method according to, claim 4 wherein recording is performed while determining a recording power for each recording linear velocity on the basis of first information of the recording power obtained by OPC and second information of an amount of the recording power to be increased according to an increase in the recording linear velocity, the second information being pre-stored in a read-in area or BCA area (Burst Cutting area).

7. The recording method according to, claim 1 wherein recording is performed on a write-once-read-many optical recording medium having a recording layer comprising an inorganic material.

8. The recording method according to claim 7, wherein the recording layer primarily comprises bismuth oxide.

9. A write-once-read-many optical recording medium comprising:
information indicating that recording is possible by CAV, ZCLV, or PCAV, and
information of a laser emission time standardized by a laser emission pattern and reference clock, the laser emission time being fixed regardless of a recording linear velocity, the laser emission pattern including a recording pulse having two or more different levels of recording power,
wherein each information is pre-stored in a read-in area or BCA area, and the write-once-read-many optical recording medium is suitable for a recording method which comprises:
recording on the write-once-read-many optical medium capable of recording and reproducing with a blue laser by CAV, ZCLV, or PCAV,
wherein the laser emission pattern including the recording pulse comprises two or more different levels of recording power, and the laser emission time standardized by the laser emission pattern and reference clock is fixed regardless of the recording linear velocity.

10. A write-once-read-many optical recording medium comprising:
information indicating that recording is possible by CAV, ZCLV, or PCAV, and
information of an amount of a recording power to be increased according to an increase in a recording linear velocity,
wherein each information is pre-stored in a read-in area or BCA area, and the write-once-read-many optical recording medium is suitable for a recording method which comprises:
recording on the write-once-read-many optical medium capable of recording and reproducing with a blue laser by CAV, ZCLV, or PCAV,
wherein a laser emission pattern including a recording pulse comprises two or more different levels of recording power, and a laser emission time standardized by the laser emission pattern and reference clock is fixed regardless of the recording linear velocity.
